(19) United States
(12) Patent Application Publication
(10) Pub. No.: US 2018/0045658 A1
(43) Pub. Date: Feb. 15, 2018

(54) MICROWAVE IMAGING DEVICE AND METHOD

(71) Applicant: KABUSHIKI KAISHA TOSHIBA, Tokyo (JP)

(72) Inventors: David Rhys GIBBINS, Bristol (GB); Ian James CRADDOCK, Bristol (GB); Tommy Nils HENRIKSSON, Bristol (GB)

(73) Assignee: Kabushiki Kaisha Toshiba

(21) Appl. No.: 15/234,398

(22) Filed: Aug. 11, 2016

(51) Int. Cl. G01N 22/00

(52) U.S. Cl. CPC G01N 22/00

(57) ABSTRACT

A microwave imaging device comprising a conductive enclosure defining an imaging region within it and an array of wideband resonators, each resonator located substantially in a plane defined by the conductive enclosure.

### FIELD

Embodiments described herein relate generally to microwave imaging devices.

### BACKGROUND

Some tomographic microwave imaging systems are known. Some known systems, however, have large overall dimensions and/or narrow bandwidth. It was recognised as desirable to provide a wide bandwidth yet compact tomographic microwave imaging system.

In the following, embodiments will be described with reference to the drawings in which:

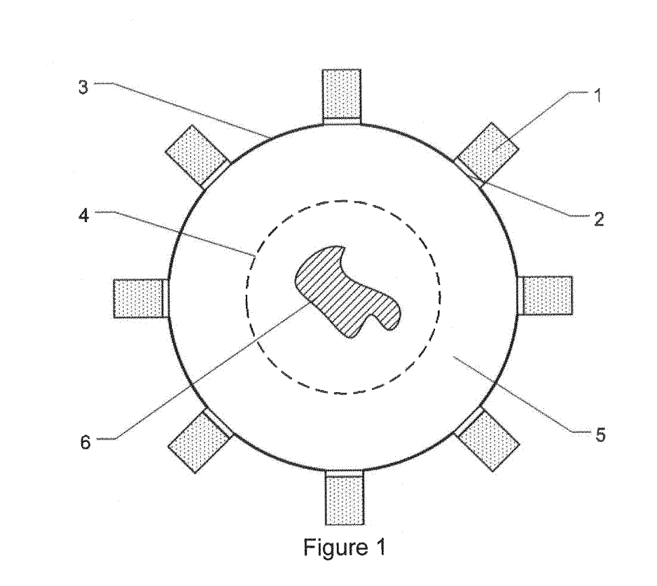

FIG. 1 shows an imaging system consisting according to an embodiment;

FIG. 2 shows an imaging system consisting according to another embodiment;

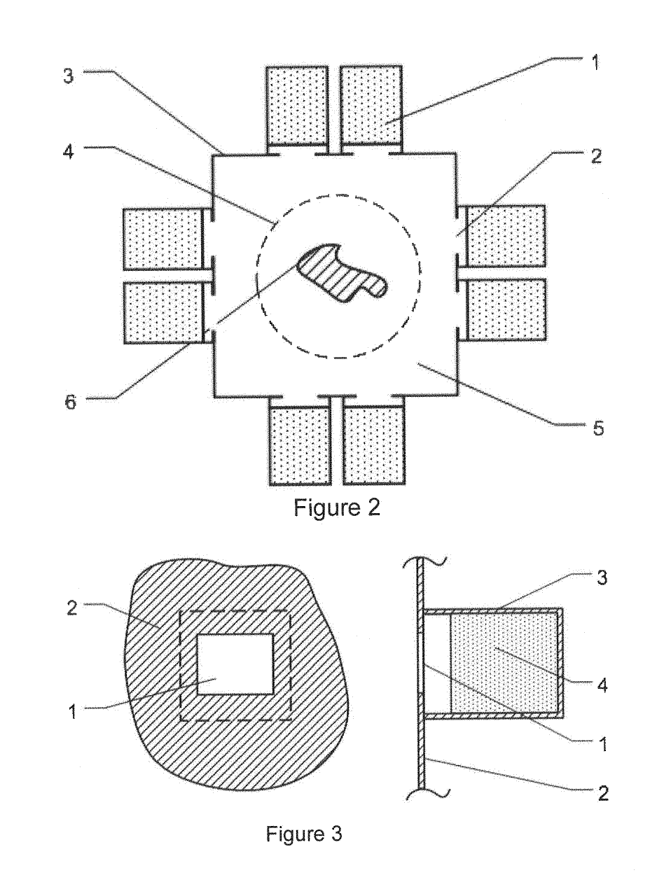

FIG. 3 shows detail of antenna interface with metal boundary;

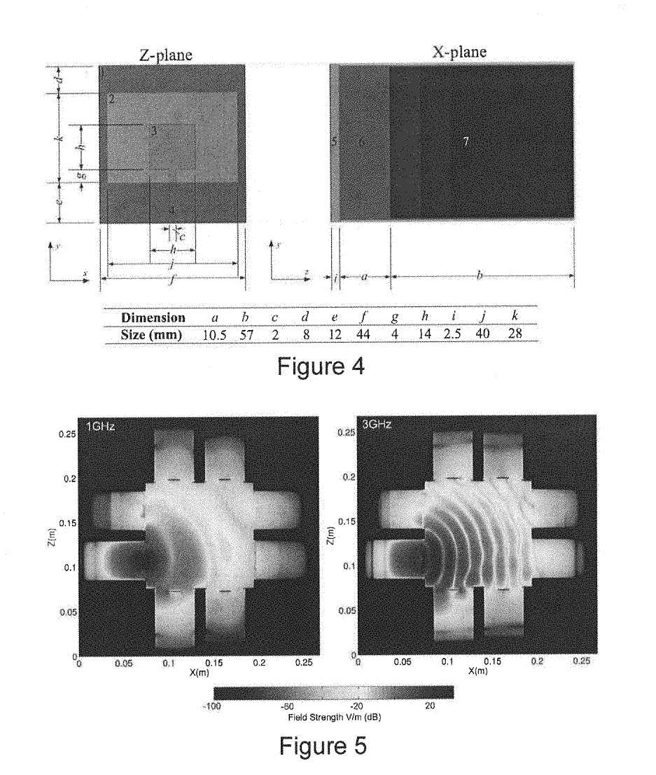

FIG. 4 shows detail and dimensions of a LCBWS antenna according to an embodiment;

FIG. 5 Y-plane cross-section through simulation domain of the imaging array the centre of the antenna elements showing the frequency domain magnitude Ey-polarised fields produced by a single antenna, at 1 GHz˜(left) and 3 GHz˜(right);

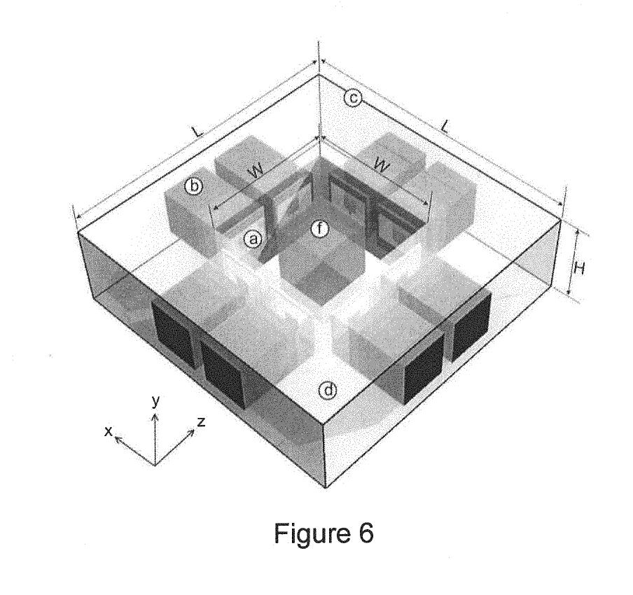

FIG. 6 shows a simulation model of an 8 antenna array for use in reconstruction;

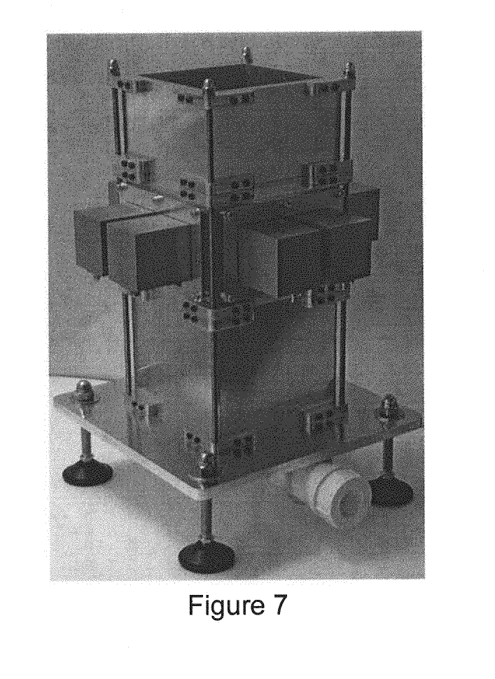

FIG. 7 a prototype of a physical 8-element MIS imaging array;

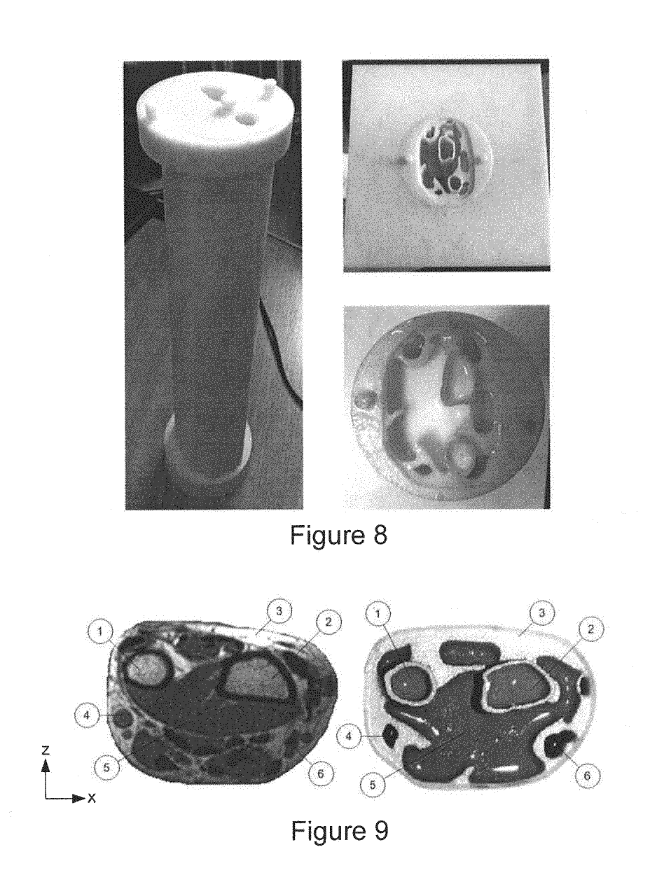

FIG. 8 shows images of an 3D printed ABS forearm phantom;

FIG. 9 shows an MRI image of an arm phantom and w cross-section through the arm phantom created based on the MRI image;

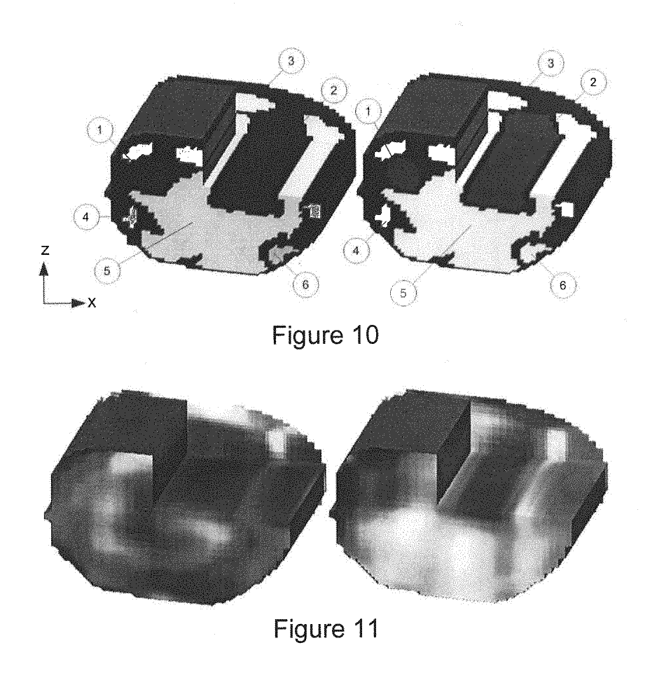

FIG. 10 shows a 3D material maps of the physical 3D printed arm phantom with healthy bone tissue at 1 GHz;

FIG. 11 shows 3D images of the physical 3D printed arm phantom with healthy bone tissue produced by an MIS algorithm;

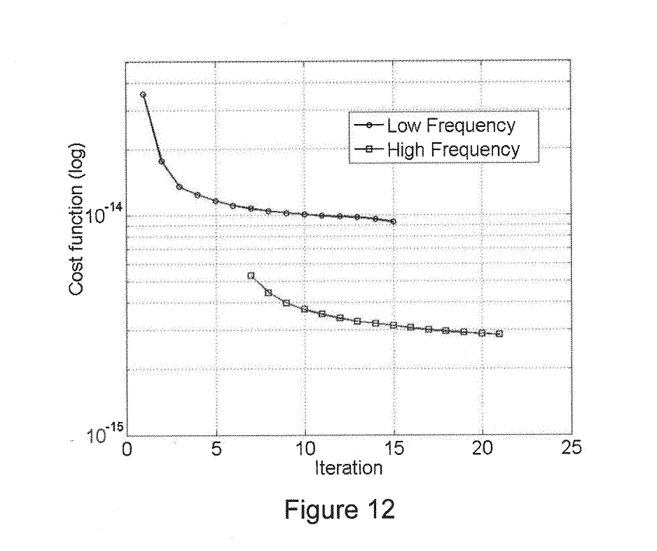

FIG. 12 shows a cost function for complete MIS reconstruction process for the healthy arm phantom; and

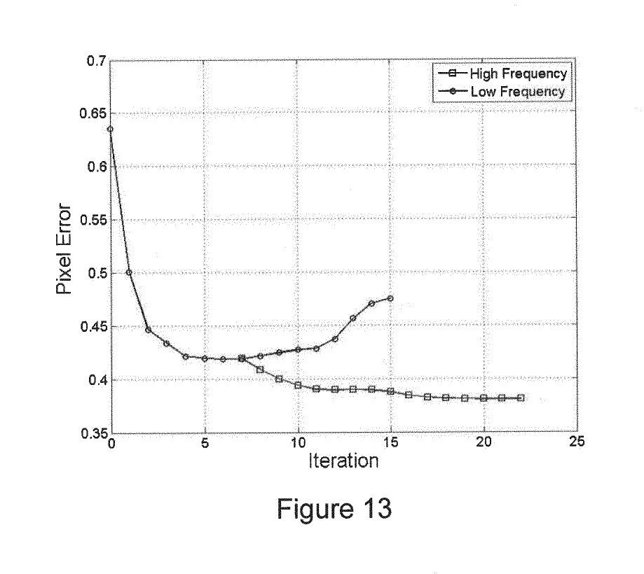

FIG. 13 shows the permittivity pixel error at plane 36 of 75 of the arm phantom for the complete MIS reconstruction process for the healthy arm phantom.

### DETAILED DESCRIPTION

According to an embodiment there is provided a microwave imaging device comprising a conductive enclosure defining an imaging region within it and an array of wideband resonators, each resonator located substantially in a plane defined by the conductive enclosure.

The conductive enclosure may define an imaging space and may extend in/define a number of planes surrounding this imaging space. The conductive enclosure may form a continuous conductive hollow or tubular boundary that is open on two opposing ends. Alternatively the conductive enclosure may form a continuous conductive hollow or tubular boundary that is closed by a conductive end surface on one of its ends, wherein the conductive end surface is conductively connected to the conductive hollow or tubular boundary. In this manner the alternative conductive enclosure is a conductive enclosure that encloses the imaging space on all sides whilst allowing access to the imaging space from one open side. In a further alternative the conductive enclosure may form a continuous conductive hollow or tubular boundary that encloses the imaging space as a continuous conductive surface on all sides, wherein part of the continuous conductive surface comprises an opening that can be closed by a conductive closure surface. An object that is to be imaged may be inserted into the conductive enclosure through this opening, with the opening, when closed with the closure surface completing the continuous conductive enclosure.

In an embodiment the plurality of wideband resonators surround the imaging region in one plane. In alternative embodiments the wideband resonators may be arranged in a plurality of planes surrounding the imaging region, for example, so that they are evenly spaced around an entire surface in three dimensions.

In an embodiment one or more or each of the plurality wideband resonators have, at any point in time, a fractional bandwidth of equal to or greater than 0.10. More preferably one or more or all of the plurality of wideband resonators is/are ultrawideband resonators that, at any point in time, have a fractional bandwidth equal to or greater than 0.20 or a bandwidth equal to or greater than 500 MHz, regardless of the fractional bandwidth.

Using wideband or, more preferably, ultrawideband resonators means that a larger quantity of information is collected by each sensor compared to narrow band systems. When combined with a time domain reconstruction algorithm fewer antennas are required to perform reconstructions than a frequency domain system. At the same time information is gathered from a wide variety of wavelengths (and therefore geometrical scales) allowing both large and small scale objects to be reconstructed. While multi-frequency narrow band systems do allow this function, combing the data from the different frequencies can be problematic whereas this is an natural and intrinsic part of time domain algorithms. Ultrawideband systems also allow the use of narrow pulse widths which shortens the simulation and consequently reconstruction times.

The imaging region may be filled with a lossy imaging medium. The use of lossy imaging medium within the conductive enclosure dampens multiple reflections. In this manner simulation times can be kept short. Preferably the imaging medium has a conductivity of at least 0.1 S/m. The lossy medium may be provided between the resonators and the imaging space. This lossy matching medium may also fill the imaging space, may be a liquid, solid or gel like substance or any combination thereof.

The device is preferably for imaging using microwave inverse scattering techniques.

As mentioned above, the resonators may be in the plane of the conductive enclosure but do not have to be placed exactly in this plane. Moving the resonator away from the imaging region so that it lies beyond/outside of the conductive enclosure and radiates into the imaging region through an aligned opening within the conductive enclosure narrows the beam created by the resonator and reduces the amount of data that can be received by the resonator. It is also possible to move the resonator forward from the conductive enclosure/towards the object under investigation/the imaging region. To ensure illumination of the object under test that is comparable to the illumination achieved by a resonator located in the plane of the conductive enclosure it is not possible to move the resonator too far towards the imaging region. Preferably the plane of the resonator is spaced no more than λ/4 from the conductive enclosure, wherein A in this instance is the longest wavelength used by the resonator for sensing and/or excitation.

Embodiments provide a tomographic microwave imaging system that is able to obtain good quality UWB measurements of a dielectric target, with a system that is as compact as possible. The embodiment has a structure that enables accurate and efficient replication of the physical measurements in a time-domain electromagnetic simulator. In this way the embodiment provides an imaging system that is able to produce good quality images at a reasonable time and resource cost using a time domain imaging algorithm. This is not possible with known technology. This embodiment in particular provides boundary conditions that are less ill-defined than those found in known systems, whilst reducing simulation volume sizes and consequently simulation and image reconstruction times. In one embodiment a 3D Time domain algorithm is used for imaging. The device of the embodiment provides particularly advantageous results when used with this algorithm.

The small size of the imaging array of the embodiment and its well defined boundary conditions, allow the entire system to be simulated, including full 3D EM models of complex antennas, in a short period of time. Due to the accuracy of the model the data that results from such simulations is of a high quality agreeing closely with measurement data. This is important for accurate 3D microwave imagining.

The conducting boundary of the embodiment means that they are well defined allowing accurate simulation of the system. The use of a lossy matching medium and the metal boundaries means that the boundaries may be placed close to the Object Under Test (OUT). The new system can therefore be smaller than the open boundary systems.

In one embodiment the device is a medical imaging device. In another embodiment the device is suitable for the non-destructive testing of objects.

In an embodiment there is provided a ultra-wide band metal cavity microwave imaging array. In another embodiment there is provided a tomographic nearfield microwave imaging array comprising cavity-backed UWB wide-slot antennas mounted in a metallic imaging chamber.

One or more or all of the wideband resonators may be resonant slot antennas mounted against an opening in the conductive enclosure or provided as slot in the conductive enclosure.

It was realised that the wide slot antennas used in an embodiment have a number of advantages over existing implementations. They have excellent wideband performance compared to other element types and so they can be used with a time domain solver inverse scattering solver. Compared to frequency domain solvers these solvers make most effective use of the information that can be obtained from a wide-bandwidth signals and can be implemented using fewer antennas. The wide slot antennas are also magnetic in nature which means that they may be placed closer to the object under test than electrical-type antennas (e.g. dipoles, monopoles) without their performance being affected. This is desirable if the system is to be as compact as possible.

In one embodiment the conductive enclosure has a cross-sectional area that comprises internal right angles, preferably a cross-section that exclusively comprises internal right angles. The cross-section may be a rectangle or a square. Square antenna arrays are particularly efficient to simulate efficiently in iterative inverse scattering schemes. Through the use of right angled geometry of the array and/or the antenna all components can conform exactly to an orthogonal, right angled Cartesian mesh used in Finite Difference Time Domain solvers. Arrangements of this nature are more accurate and/or more efficient than arrangements in which curved or non-right angled geometry is employed. In the latter cases either a very fine mesh must be used to describe these features, which results in many cells and long simulation times, or a more complex conformal algorithm is required, which again would be less efficient.

In one embodiment the microwave imaging device further comprises conducting cavities shielding individual ones of the wideband resonators on a side of the conductive enclosure opposite to the side at which the imaging region is located. These conductive cavities render the resonator insensitive to electromagnetic influences originating on a side of the conductive enclosure opposite to the imaging region. The directive nature of the antennas created in this manner means that energy is only radiated into and received from the target.

Some known systems use wire-type antennas located within a large imaging tank constructed of a non-metallic material. This type of antenna is easy to simulate. However its omnidirectional radiation pattern and electrical nature means that they must be placed far from the simulation boundary. This requires large simulation spaces and consequently long simulation times. Embodiments described herein alleviate these problems. The embodiments moreover eliminate backscatter from and isolates the back side of the slot antennas while defining a boundary condition on the backside of the slot. This arrangement has the advantages of giving well defined boundary conditions to an imaging system that has a small volume.

The conducting cavities may comprise an electromagnetic wave absorbing material.

The resonator in one embodiment comprises a slot comprising internal right angles within a conducting ground plane and/or a right angled stub located within a slot comprising internal right angles and located in a conducting ground plane. In one embodiment the slot is rectangular or square. In an embodiment the stub is rectangular or square.

In another embodiment there is provided a microwave imaging system comprising a microwave imaging device as described above and computer executable code that, when executed by an electromagnetic field modeller, creates a representation of the device for use by the modeller in modelling the electromagnetic conditions within the device.

In another embodiment there is provided computer executable code that, when executed by an electromagnetic field modeller, creates a representation of a device as described above for use by the modeller in modelling the electromagnetic conditions within the device.

In another embodiment there is provided a method of microwave imaging using a model of any of the devices described above to generate an image of an object under test using a time domain inverse scattering algorithm from imaging data of an object under test that had been acquired using the microwave imaging device.

Preferably a 3D reconstruction algorithm is used.

FIG. 1 shows an imaging system according to an embodiment. The system comprises a plurality of metal cavities 1, an ultra-wideband (UWB) slot antenna 2 associated with each of the metal cavities 1 and a conductive boundary 3. The conductive boundary 3 and the slot antennas 2 surround an imaging region 4 defined within conductive boundary 3. The object to be imaged can be located, in use, in the imaging region 4. An imaging medium 5 is provided within the imaging region for impedance matching purposes.

In the embodiment the UWB slot antenna 2 is formed by providing a resonant slot in the conductive boundary 3. The metal cavity 1 (in one embodiment made of copper) backing the slot is non-resonant and serves to shield the slot 2 from electromagnetic radiation originating on the side of the conductive boundary 3 that is opposite to the imaging region 4. It will be appreciated that the presence of the metal cavities increases the directivity of the slot antennas 2. To further improve the directivity of the slot antennas 2 in the embodiment the metal cavities 1 are filled with a foam that absorbs electromagnetic radiation. It will, however, be appreciated that the use of this foam is not essential.

FIG. 2 shows a further embodiment of an imaging apparatus. In his embodiment the conducting boundary 3 has a square cross-section instead of a circular cross-section as was the case in the embodiments described above with reference to FIG. 1. All other components of the embodiment shown in FIG. 2 are the same as their equivalent components shown in FIG. 1.

FIG. 3 shows the interface between the metal boundary (identified by reference numeral 2 in this figure) and the slot antenna (identified by reference numeral 1 in this figure), the metal cavity (identified by reference numeral 3 in this figure) backing the slot antenna and the absorbing foam (identified by reference numeral 4 in this figure). The left-hand side of FIG. 3 provides a view of the antenna looking from the imaging region outwards towards the antenna whereas the right-hand side of FIG. 3 shows a cross-sectional cut through the centre of the metal cavity 3 that would, in FIGS. 1 and 2 extend orthogonally to the drawings plane. As can be seen, the absorbing foam material is provided so that it fills the back part of the metal cavity 3, that is the part that is located away from the resonant slot 1 but does not extend to the resonant slot 1.

Line drawings of a slot antenna according to an embodiment are moreover provided in FIG. 4, wherein, again, the left-hand side shows a radially outward view into the slot antenna from the imaging region and the right-hand side shows a cross-sectional cut through the conducting cavity in the same manner as the right-hand side of FIG. 3. The antenna comprises a conducting ground plane (identified by reference numeral 1 in FIG. 4), a wide slot aperture (identified by reference numeral 2 in FIG. 4), a square stub (identified by reference numeral 3 in FIG. 4) terminates a 50Ω micro-strip feed line (identified by reference numeral 4 in FIG. 4). In the embodiment the conducting ground plane is provided on one side of the substrate whilst the micro-strip feed line as well as the square stub are provided on the opposite side of the substrate. The conducting ground plane 1 is provided on substrate (identified by reference numeral 5 in FIG. 4) in the embodiment. It will though be appreciated that this is not essential and that the conducting ground plane 1 can be sufficiently thick to be self-supporting. An air gap (identified by reference numeral 6 in FIG. 4) is provided between the substrate and the absorber (identified by reference numeral 7 in FIG. 4). Exemplary dimensions are also provided in FIG. 4, although these are of course not limiting. The absorbing material is spaced 10.5 mm from the back surface of the substrate to minimise losses caused by coupling between the absorber and microstrip. The absorber is modelled using a 6 layer perfectly matched layer, each 9.5˜mm thick. All have a relative permittivity of free space and conductivity values that vary exponentially from 1.45×10⁻³ S/m closest to the antenna, to 21.2 S/m in the final layer. The main computational overhead in iterative inverse scattering algorithms is the repeated simulation of the forward model. It is imperative that the EM model of the measurement array be as efficient as possible to minimise reconstruction times. Therefore the antenna design is composed of rectangular elements, discretised with a sparse mesh that has a minimum cell size of 0.5 mm. Models of complex antennas tend to require a fine mesh because of their geometric details. This is not the case for the geometry of the embodiment, with the minimum cell size mentioned here being close to the mesh size of 0.67 mm that would be used if the model was unrestrained by the need to describe the antenna geometry. In an embodiment a Finite Difference Time Domain (FDTD) solver with a regular Cartesian mesh is used. Using a larger minimum mesh size in this solver has the advantage of limiting simulation time. This is based on a maximum frequency of 5 GHz, relative permittivity of 80 and cell size of λ/10 (λ=wavelength). This geometry means that it can be modelled using a simple yet efficient Cartesian based FDTD solver. Another antenna suitable for use in an embodiment is known from US 2011/0263961.

Because the antenna shown in FIG. 4 has been designed specifically with large rectangular elements it maybe efficiently and accurately modelled with a Cartesian mesh. If a square array is also used (as shown in FIG. 2) all elements can be modelled in this way. This enables the system to obtain high quality wideband data.

FIG. 5 shows the results of simulations of an imaging device in a cross-section of the device extending through the centres of all of the antennas. The simulation is of a mode in which one of the antennas is excited and the remaining antennas act as receivers. The frequency domain magnitude of the electric field components polarised in the y-direction (i.e. the direction aligned with the vertical/y axis) produced by a single antenna, at 1 GHz˜(left) and 3 GHz˜(right) are shown in these figures. One concern when using a square array geometry is that the antennas will not be able to Illuminate the object under test in a uniform and consistent manner with frequency. Most known systems have a circular geometry to avoid this issue. The simulation results shown in this figure indicate that, because of the wide beam width of the wide slot, this is not a problem. Preferably, the −10 dB beam width is at least 110 degrees between 1 and 4 Ghz to ensure that the object to be examined is sufficiently illuminated.

FIG. 6 shows an eight antenna array used for reconstructing images from data acquired using the imaging cavity. a. is the antenna element; b. is the absorber filled cavity; c. is the FDTD simulation region; d is the block of perfect electrical conductor that, in the simulation, forms the body of the array; e. is the MRI based forearm phantom described in further detail below and f. is the update region within which the reconstruction algorithm is applied.

FIG. 7 shows a prototype of an 8-element microwave inverse scattering imaging array in its final form with adjustable legs and out-pipe for easily emptying matching medium.

FIG. 8 shows a 3D printed ABS phantom of a forearm phantom (left), complete in its full length with the phantom lid and bone tubes fitted. At the top right the phantom as fitted into the top lid with 5° spaced rotation marks being illustrated. At the bottom right of this figure a top view of the phantom filled with tissue mimicking liquids is provided.

FIG. 9 shows an MRI image of a human forearm (left) and a cross-section through the arm phantom (right). The ulna is identified by reference numeral 1, the radius is identified by reference numeral 2, adipose (fatty) tissue is identified by reference numeral 3, blood vessels are identified by reference numerals 4 and 6 and muscle is identified by reference numeral 5.

FIG. 10 shows a 3D material maps of the physical 3D printed arm phantom with healthy bone tissue at 1 GHz, with the conductivity of the phantom being shown on the left and its permittivity shown on the right. The ulna is identified by reference numeral 1, the radius is identified by reference numeral 2, adipose (fatty) tissue is identified by reference numeral 3, blood vessels are identified by reference numeral 4 and 6 and muscle is identified by reference numeral 5.

FIG. 11 shows 3D images of the physical 3D printed arm phantom with healthy bone tissue produced by the microwave inverse scattering (MIS) algorithm (T. Takenaka, H. Zhou, and T. Tanaka, “Inverse scattering for a three-dimensional object in the time domain,” J. Opt. Soc. Am. A 20, 1867-1874, 2003), after 15 iterations of the solver, in the high frequency part of the reconstruction. Conductivity is shown on the left and permittivity is shown on the right.

FIG. 12 shows a cost function for complete MIS reconstruction process for the healthy arm phantom. The cost function has been computed as described in I. T. Rekanos, Inverse scattering in the time domain: an iterative method using an FDTD sensitivity analysis scheme, IEEE Trans. Magn., vol. 38, no. 2, pp. 11171120, March 2002.

FIG. 13 shows the permittivity pixel error (determined according to A. Fhager, S. K. Padhi, and J. Howard, 3D Image Reconstruction in Microwave Tomography Using an Efficient FDTD Model, IEEE Antennas Wirel. Propag. Lett., vol. 8, pp. 1353-1356, 2010) at plane 36 of 75 of the arm phantom for the complete MIS reconstruction process for the healthy arm phantom.

Compared to existing technology the embodiment described herein allows a directional wideband antenna to be placed close to target object while at the same time minimising the volume of the imaging system.

An imaging system consisting of the physical array shown in FIG. 7 and an FDTD model (shown in FIG. 6B) used in the inverse scattering solver has been developed. This system has been used in conjunction with a time domain Inverse scattering algorithm to image the human forearm phantom shown in FIG. 8 and the right-hand side of FIG. 9. This phantom is based on the 2D section of the MRI image shown on the left-hand side of FIG. 9 and is constructed from ABS plastic using 3D printing technology. The plastic represents fatty tissue, while other tissues are modelled using a tissue mimicking liquid. Experimental results have shown that the system is able to reconstruct the material properties of the arm phantom (as shown in FIG. 10) to a reasonable degree of accuracy (as shown in FIG. 11). This visual assessment is confirmed by metrics that compare the error between the phantom and reconstructed Image in terms of scattered electromagnetic field (FIG. 12) and a direct comparison of pixel material values (FIG. 13). These metrics show that as the iterative reconstruction algorithm progresses, between the ground truth and the reconstructed image decreases.

Whilst certain embodiments have been described, these embodiments have been presented by way of example only, and are not intended to limit the scope of the inventions. Indeed, the novel devices, and methods described herein may be embodied in a variety of other forms; furthermore, various omissions, substitutions and changes in the form of the devices, methods and products described herein may be made without departing from the spirit of the inventions. The accompanying claims and their equivalents are intended to cover such forms or modifications as would fall within the scope and spirit of the Inventions.

1. A microwave imaging device comprising
a conductive enclosure defining an imaging region within it; and
an array of wideband resonators, each resonator located substantially in a plane defined by the conductive enclosure.

2. A microwave imaging device according to claim 1, wherein one or more or all of the wideband resonators are resonant slot antennas mounted against an opening in the conductive enclosure or provided as slot in the conductive enclosure.

3. A microwave imaging device according to claim 1, wherein the conductive enclosure has a cross-sectional area that comprises internal right angles.

4. A microwave imaging device according to claim 1, further comprising conducting cavities shielding individual ones of the wideband resonators on a side of the conductive enclosure opposite to the side at which the imaging region is located.

5. A microwave imaging device according to claim 4, wherein the conducting cavities comprise an electromagnetic wave absorbing material.

6. A microwave imaging device according to claim 1, wherein the resonator comprises:
a slot comprising internal right angles within a conducting ground plane and/or
a right angled stub located within a slot comprising internal right angles and located in a conducting ground plane.

7. A microwave imaging device according to claim 1, further comprising a lossy matching medium between the resonators and the object under test.

8. A microwave imaging system comprising a microwave imaging device according to claim 1 and computer executable code that, when executed by an electromagnetic field modeller, creates a representation of the device for use by the modeller in modelling the electromagnetic conditions within the device.

9. Computer executable code that, when executed by an electromagnetic field modeller, creates a representation of a device according to claim 1 for use by the modeller in modelling the electromagnetic conditions within the device.

10. A method of microwave imaging comprising:
using a model of a device according to any preceding claim to generate an image of an object under test using a time domain inverse scattering algorithm from imaging data of an object under test that had been acquired using the microwave imaging device.
